(19) United States
(12) Patent Application Publication
(10) Pub. No.: US 2014/0307766 A1
(43) Pub. Date: Oct. 16, 2014

(54) ITERATIVELY SCANNING EQUALIZATION COEFFICIENTS TO OPTIMIZE SIGNAL QUALITY IN A DATA COMMUNICATION LINK

(71) Applicant: NVIDIA Corporation, Santa Clara, CA (US)

(72) Inventors: Feroze Karim, Bangalore (IN); Vishal Mehta, San Jose, CA (US); Hungse Cha, Austin, TX (US); Hitendra Dutt, Sunnyvale, CA (US); Dennis Ma, Austin, TX (US)

(73) Assignee: NVIDIA Corporation, Santa Clara, CA (US)

(21) Appl. No.: 13/863,399

(22) Filed: Apr. 16, 2013

(51) Int. Cl. H04L 27/01

(52) U.S. Cl. CPC H04L 27/01
USPC 375/232

(57) ABSTRACT

A method includes iteratively scanning, through a processor, at least a portion of a map of equalization coefficients related to channel equalization in a data communication link based on an ordinal integer step size S>1 for N (N>1) different sequences thereof to determine optimal points therein for which a signal quality in the data communication link is optimal. The method also includes performing, through the processor, a fine search for optimal equalization coefficients based on the determined optimal points.

### FIELD OF TECHNOLOGY

This disclosure relates generally to multimedia content analysis and, more particularly, to a method, a device and/or a system of iteratively scanning equalization coefficients to optimize signal quality in a data communication link.

### BACKGROUND

Optimizing signal quality in a data communication link (e.g., a serial communication link compatible with a Peripheral Component Interface Express (PCIe)-based protocol) may involve equalization. Equalization may involve distorting a data signal through a transformation corresponding to an inverse of a response of the channel for communication. Once the equalization coefficients are found, a map thereof may be scanned to determine the set of coefficients for which the signal quality in the data communication link is optimum (e.g., a maximum). However, a time taken for the scanning may exceed a threshold specified, thereby leading to an optimal set of coefficients not being determined accurately.

### SUMMARY

Disclosed are a method, a device and/or a system of iteratively scanning equalization coefficients to optimize signal quality in a data communication link.

In one aspect, a method includes iteratively scanning, through a processor, at least a portion of a map of equalization coefficients related to channel equalization in a data communication link based on an ordinal integer step size S>1 for N (N>1) different sequences thereof to determine optimal points therein for which a signal quality in the data communication link is optimal. The method also includes performing, through the processor, a fine search for optimal equalization coefficients based on the determined optimal points.

In another aspect, a system includes a transmitter device, a receiver device, and a data communication link to serve as an information path between the transmitter device and the receiver device. The transmitter device and/or the receiver device include a processor communicatively coupled to a memory, with the processor being configured to execute instructions to iteratively scan at least a portion of a map of equalization coefficients related to channel equalization in the data communication link based on an ordinal integer step size S>1 for N (N>1) different sequences thereof to determine optimal points therein for which a signal quality in the data communication link is optimal. The processor is also configured to execute instructions to perform a fine search for optimal equalization coefficients based on the determined optimal points.

In yet another aspect, a device includes a memory and a processor communicatively coupled to the memory. The processor is configured to execute instructions to iteratively scan at least a portion of a map of equalization coefficients related to channel equalization in a data communication link based on an ordinal integer step size S>1 for N (N>1) different sequences thereof to determine optimal points therein for which a signal quality in the data communication link is optimal. The processor is also configured to execute instructions to perform a fine search for optimal equalization coefficients based on the determined optimal points.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a system configured to have transmission of information between two devices thereof, according to one or more embodiments.

FIG. 2 is a view of an example two dimensional map of equalization coefficients associated with a channel of the system of FIG. 1.

FIG. 3 is a schematic view of a coarse search process through the map of FIG. 2, according to one or more embodiments.

FIG. 4 is a schematic view of another iterative walk sequence of the coarse search process of FIG. 3.

FIG. 5 is a flowchart detailing the operations involved in the coarse search process of FIGS. 3-4, according to one or more embodiments.

FIG. 6 is a process flow diagram detailing the operations involved in iteratively scanning equalization coefficients to optimize signal quality in a data communication link of the system of FIG. 1, according to one or more embodiments

Other features of the present embodiments will be apparent from the accompanying drawings and from the detailed description that follows.

### DETAILED DESCRIPTION

Example embodiments, as described below, may be used to provide a method, a system and/or a device of iteratively scanning equalization coefficients to optimize signal quality in a data communication link. Although the present embodiments have been described with reference to specific example embodiments, it will be evident that various modifications and changes may be made to these embodiments without departing from the broader spirit and scope of the various embodiments.

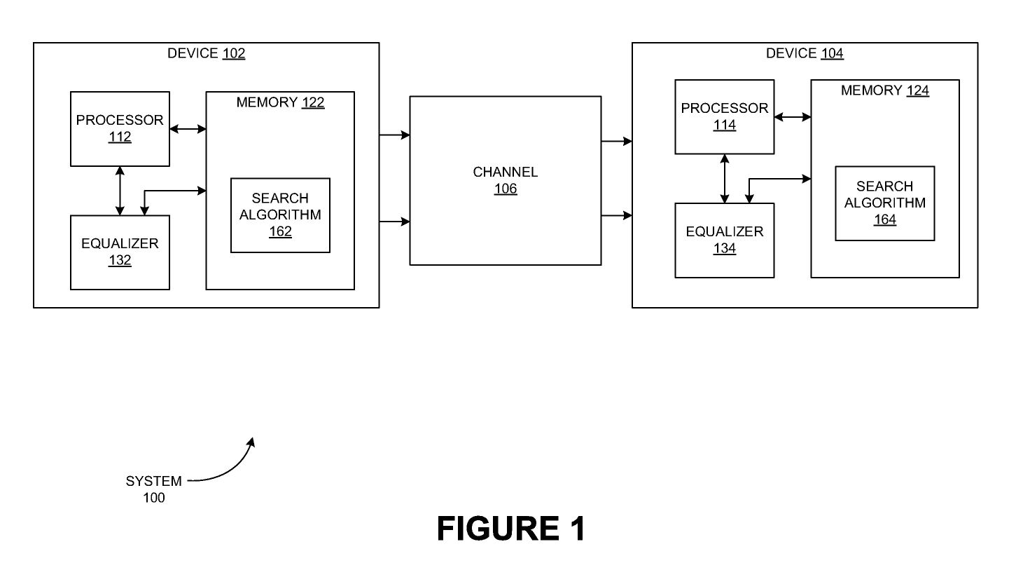

FIG. 1 shows a system 100 configured to have transmission of information between device 102 and device 104 thereof, according to one or more embodiments. In one or more embodiments, device 102 and/or device 104 may be computing devices (e.g., servers, personal computers and the like); alternately device 102 and/or device 104 may be an initiator host device (e.g., of a Serial-Attached Small Computer System Interface (SAS)-based system), a target device, an expander device or a storage device (e.g., disk drives). Other forms of device 102 and/or device 104 are within the scope of the exemplary embodiments discussed herein.

In one or more embodiments, channel 106 may be a transmission path between device 102 and device 104; for example, information may be transmitted in serial. FIG. 1 shows each of device 102 and device 104 as including a processor (112, 114) communicatively coupled to a memory (122, 124); memory (122, 124) may include storage locations configured to be addressable by processor (112, 114). Memory (122, 124) may be a volatile memory and/or a non-volatile memory. Processor (112, 114) may be a Central Processing Unit (CPU), a Graphics Processing Unit (GPU) or a dedicated microprocessor including a microcontroller. Channel 106 may an optical-fiber/cable based transmission medium; collectively passive components of a serial-communication link including high-speed connectors may be termed channel 106.

In an alternate implementation, device 102 and device 104 may be part of the same computing system/device. Such variations are within the scope of the exemplary embodiments discussed herein. Device 102 may serve as a transmitter and device 104 may serve as receiver in FIG. 1. In an electronic signal, the process of adjusting the balance between frequency components therewithin may be termed “equalization.” Channel 106 may attenuate some frequency components of the electronic signal more than other components thereof, which renders the electronic signal unintelligible at the receiving end. When channel 106 is equalized, the frequency domain attributes of the electronic signal at the input end may faithfully be reproduced at the output end. In systems involving signals compatible with high-speed serial communication protocols such as Peripheral Component Interconnect Express (PCIe)-based protocols, equalizers (e.g., equalizers 132 and 134) may be utilized to prepare data signals for transmission.

The equalization discussed above may involve distorting a data signal through a transformation corresponding to an inverse of a response of channel 106. In one or more embodiments, equalization may be employed at device 102 and/or device 104. FIG. 1 shows equalization as capable of being performed at both device 102 and device 104 for example purposes. It should be noted that equalization may also be performed at a device (or, as a standalone basis) distinct from both device 102 and device 104. Such variations are within the scope of the exemplary embodiments discussed herein. Equalization is well known to one skilled in the art; therefore, detailed discussion thereof has been skipped for the sake of convenience, clarity and brevity.

Equalization may involve decision making. The data bits preceding a current data bit under decision may influence a signal value of the current data bit. The aforementioned undesired influence may be termed postcursor interference. Also, the signal value of the current data bit may be influenced by succeeding data bits. The aforementioned undesired influence may be termed precursor influence. Thus, in one or more embodiments, necessary corrections may be incorporated through equalizer 132 and/or equalizer 134. The aforementioned corrections may be generated as precursors and postcursors. Processor 112/114 may also be employed in conjunction with equalizer 132/134 for the generation of precursors and postcursors.

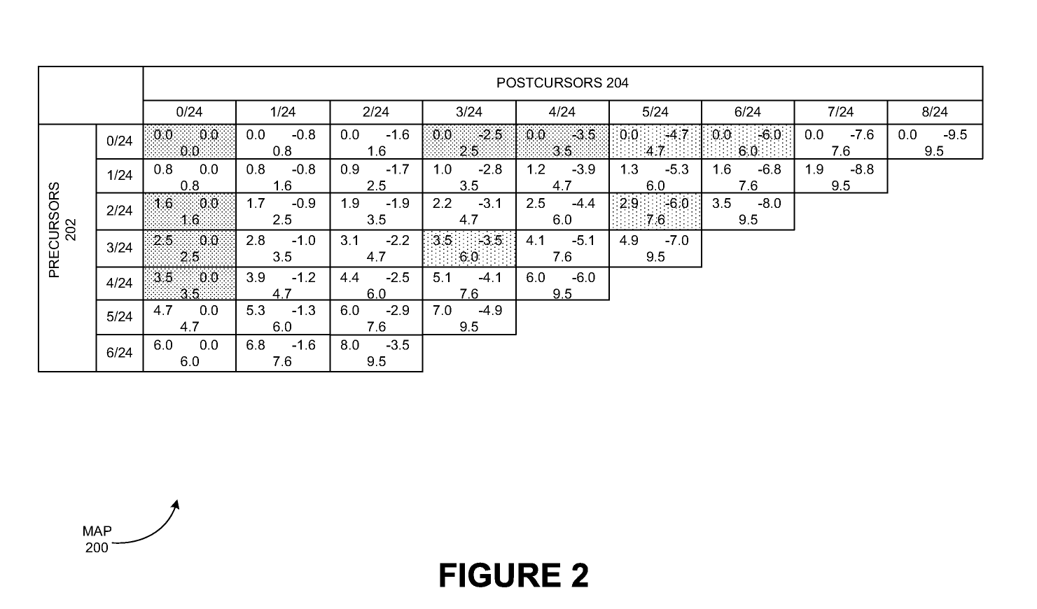

FIG. 2 shows a two dimensional map 200 of equalization coefficients, viz. precursors 202 and postcursors 204 associated with channel 106. For each postcursor 204, a corresponding precursor 202 may be available. The goal of a search algorithm (e.g., search algorithm 162/164 shown in FIG. 1 as being stored in memory 122/124) executing on processor 112/114 may be to accurately locate a postcursor 204/precursor 202 pair for which a quality of the signal is optimal (e.g., maximum based on a threshold or a mathematical calculation; instructions therefor may be stored in memory 122/124).

In one or more embodiments, there may be no set search portions of channel 106 where optimal coefficient pairs lie. Therefore, in one or more embodiments, all points on map 200 may need to be tested if possible. In an example implementation, each point may take approximately 200 μs to be evaluated, while the specification related to the communication protocol may merely provide for an allotted time of 24 ms for the entire search process. The aforementioned 24 ms total search time may be divided into two parts—one for a coarse search (say, ˜22 ms) and one for a fine search (say, ˜2 ms). The coarse search may involve a coarse searching of points of map 200 to determine a first region where the optimal coefficients are most likely to be found. The fine search may then involve exploring the region/space around the first region with the aim of successively refining better points to arrive at the optimal point(s).

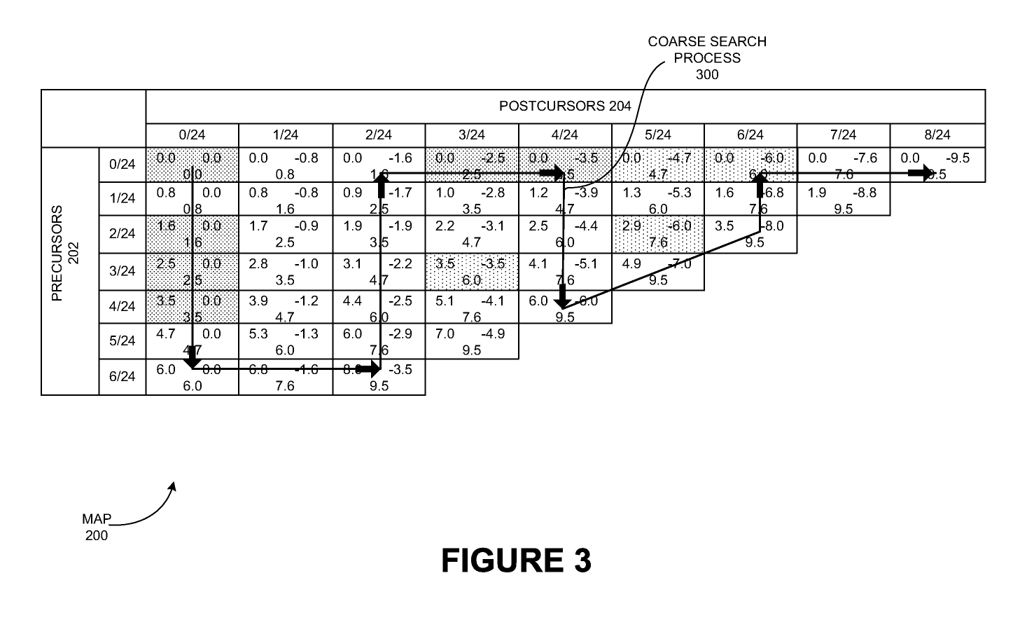

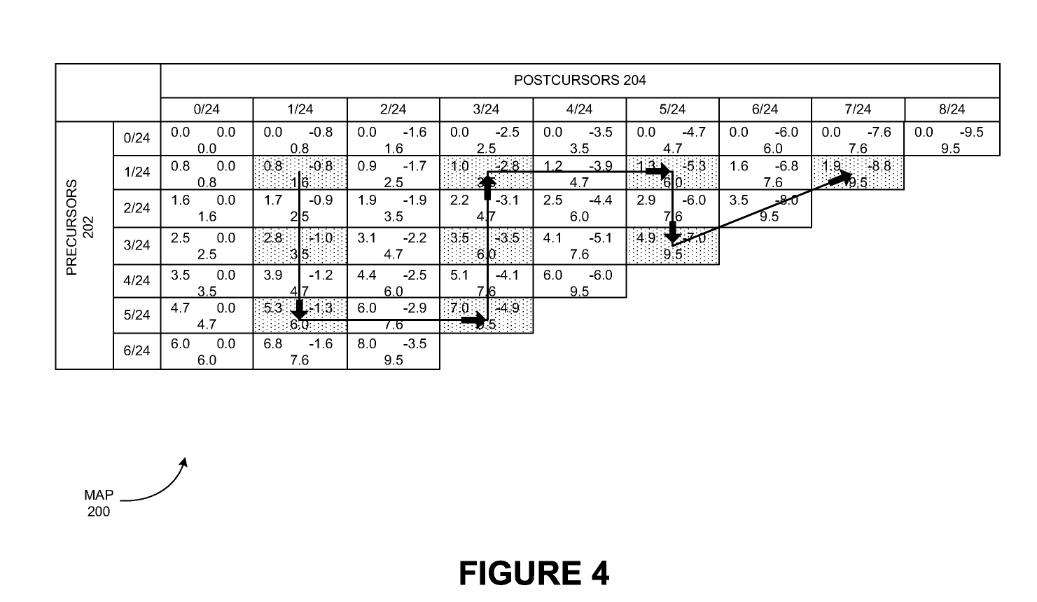

FIG. 3 shows a coarse search process 300 through map 200, according to one or more embodiments. In one or more embodiments, coarse search process 300 may involve iteratively walking through map 200 based on an ordinal integer step size S>1 (e.g., a step size of 2). For example, a sequence that starts at (0,0) may cover the points on map 200 in the order shown in FIG. 3, viz. (0,0), (0,2), (0,4), (0,6), (2,6), (2,4), (2,2), (2,0), (4,0), (4,2), (4,4), (6,2), (6,0), (8,0). Further, in one or more embodiments, the iterative walking may proceed based on the ordinal step size for N sequences (N>1; say, 4). For example, a sequence starting from (1,1) instead of (0,0) may iteratively walk map 200 as shown in FIG. 4. In this manner, N sequences may be traversed; for example when N=4, the sequences may be traversed starting from (0,0), (1,1), (0,1) and (1,0).

In one or more embodiments, if search algorithm 162/164 related to coarse search process 300 runs out of time before the N sequences are completed, the best point found thus far may be stored in memory 122/124 and utilized during the fine search process. In one or more embodiments, the fine search process may thus start from a point that is likely to be close to the optimal point of map 200.

To summarize, in one or more embodiments, by breaking coarse search process 300 into N sequences, search algorithm 162/164 may be able to cover a wide area of map 200 during the early phase of the searching, and then cover the entire map 200 if time permits. In one or more embodiments, if system 100 involves a long channel 106 (e.g., systems involving servers), channel 106 may be extremely noisy; the subset of acceptable coefficients may be extremely small. Here, in one or more embodiments, search algorithm 162/164 implementing coarse search process 300 may quickly identify a region of map 200 where close-to-optimal points are present, thereby enabling the fine search process to start at a good point if time runs out.

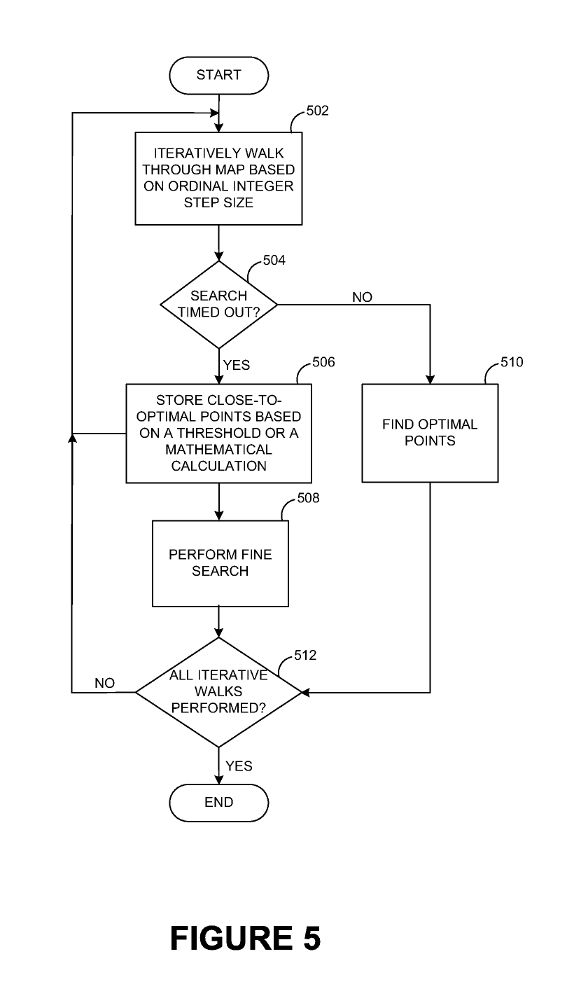

FIG. 5 shows a flow chart summarizing the search process implemented in search algorithm 162/164, according to one or more embodiments. In one or more embodiments, operation 502 may involve iteratively walking through map 200 based on the ordinal integer step size discussed above. In one or more embodiments, operation 504 may involve checking whether the coarse search process is timed out. In one or more embodiments, if yes, operation 506 may involve storing the close-to-optimal points based on a threshold or a mathematical calculation. In one or more embodiments, operation 508 may then involve performing the fine search process as discussed above. In one or more embodiments, if the result of operation 504 is a no, operation 510 may involve finding the optimal points as discussed above.

In one or more embodiments, operation 512 may involve checking as to whether all iterative walks have been performed. In one or more embodiments, if no, control may once again pass to operation 502.

It should be noted that exemplary embodiments are not limited to covering the entire area of map 200. Covering a portion of map 200 based on the iterative walking discussed above is also within the scope of the exemplary embodiments. The precursors 202 and postcursors 204 may be generated through equalizer 132/134 (e.g., hardware and/or software) in optional conjunction with processor 112/114. It should also be noted that processor 112/114 may be part of equalizer 132/134 or at least associated therewith. Further, instructions associated with the abovementioned coarse search process 300 may be implemented in firmware and stored in memory 122/124.

Last but not the least, predictions (rough or accurate) of optimal points through software (e.g., executing on processor 112/114) may be combined with full or partial predictions through coarse search process 300 (and the later fine search process) to obtain/refine accurate results. All such variations are within the scope of the exemplary embodiments discussed herein.

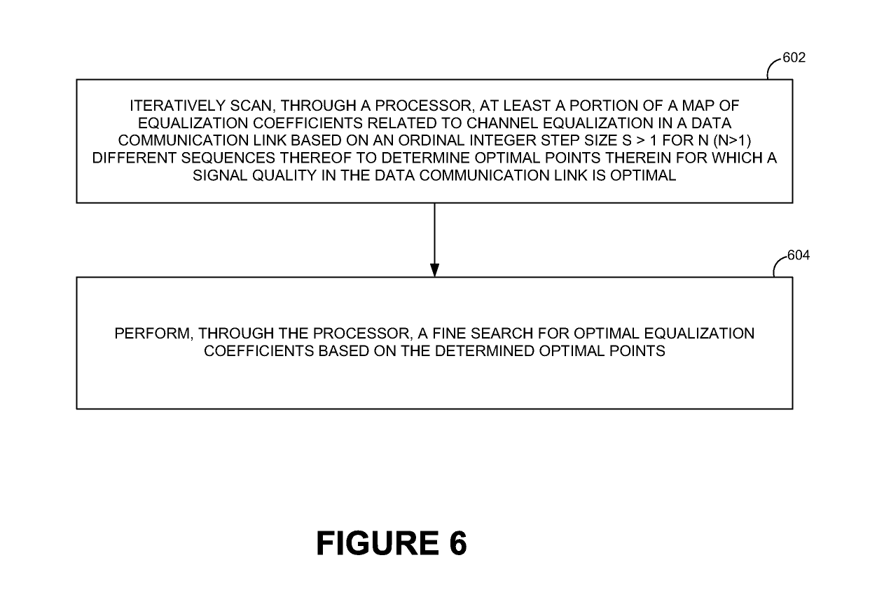

FIG. 6 shows a process flow diagram detailing the operations involved in iteratively scanning equalization coefficients to optimize signal quality in a data communication link, according to one or more embodiments. In one or more embodiments, operation 602 may involve iteratively scanning, through processor 112/114, at least a portion of map 200 of equalization coefficients related to channel equalization in a data communication link based on an ordinal integer step size S>1 for N different sequences thereof to determine optimal points therein for which signal quality in the data communication link is optimal. In one or more embodiments, N>1. In one or more embodiments, operation 604 may then involve performing, through processor 112/114, a fine search for optimal equalization coefficients based on the determined optimal points.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., device 102, device 104). Accordingly, the specification and drawings are to be regarded in an illustrative rather than a restrictive sense.

What is claimed is:

1. A method comprising:
iteratively scanning, through a processor, at least a portion of a map of equalization coefficients related to channel equalization in a data communication link based on an ordinal integer step size S>1 for N different sequences thereof to determine optimal points therein for which a signal quality in the data communication link is optimal, N>1; and
performing, through the processor, a fine search for optimal equalization coefficients based on the determined optimal points.

2. The method of claim 1, wherein when the iterative scanning is timed out, the method further comprises:
determining an optimal point to be a best point found thus far; and
utilizing the determined optimal point to perform the fine search.

3. The method of claim 1, wherein the data communication link is a serial data communication link.

4. The method of claim 1, comprising determining the optimal signal quality based on at least one of: a threshold level and a mathematical calculation performed by the processor.

5. The method of claim 1, comprising determining the equalization coefficients through at least one of an equalizer and the processor.

6. The method of claim 1, utilizing another prediction of the optimal points in conjunction with the iterative scanning through the processor to further refine the optimal points.

7. The method of claim 5, further comprising at least one of:
providing the equalizer at least one of: at a transmitter side of the data communication link, at a receiver side thereof, and outside the transmitter side and the receiver side; and
generating precursors and postcursors to be included in the map of equalization coefficients, a precursor being related to a correction performed to account for an influence of succeeding data bits on a current data bit under decision, and a postcursor being related to a correction performed to account for an influence of preceding data bits on the current data bit under decision.

8. A system comprising:
a transmitter device;
a receiver device;
a data communication link to serve as an information path between the transmitter device and the receiver device, at least one of the transmitter device and the receiver device including a processor communicatively coupled to a memory, with the processor being configured to execute instructions to:
iteratively scan at least a portion of a map of equalization coefficients related to channel equalization in the data communication link based on an ordinal integer step size S>1 for N different sequences thereof to determine optimal points therein for which a signal quality in the data communication link is optimal, N>1, and
perform a fine search for optimal equalization coefficients based on the determined optimal points.

9. The system of claim 8, wherein when the iterative scanning is timed out, the processor is configured to execute instructions to:
determine an optimal point to be a best point found thus far, and
utilize the determined optimal point to perform the fine search.

10. The system of claim 8, wherein the data communication link is a serial data communication link.

11. The system of claim 8, wherein the processor is configured to determine the optimal signal quality based on at least one of: a threshold level and a mathematical calculation.

12. The system of claim 8, further comprising an equalizer to determine the equalization coefficients one of: solely and in conjunction with the processor.

13. The system of claim 8, wherein the processor is configured to utilize another prediction of the optimal points in conjunction with the iterative scanning to further refine the optimal points.

14. The system of claim 12, wherein at least one of:
the equalizer is provided at least one of: at a transmitter side of the data communication link, at a receiver side thereof, and outside the transmitter side and the receiver side, and
precursors and postcursors to be included in the map of equalization coefficients are generated through at least one of the equalizer and the processor, a precursor being related to a correction performed to account for an influence of succeeding data bits on a current data bit under decision, and a postcursor being related to a correction performed to account for an influence of preceding data bits on the current data bit under decision.

15. A device comprising:
a memory; and
a processor communicatively coupled to the memory, the processor being configured to execute instructions to:
iteratively scan at least a portion of a map of equalization coefficients related to channel equalization in a data communication link based on an ordinal integer step size S>1 for N different sequences thereof to determine optimal points therein for which a signal quality in the data communication link is optimal, N>1, and
perform a fine search for optimal equalization coefficients based on the determined optimal points.

16. The device of claim 15, wherein when the iterative scanning is timed out, the processor is further configured to execute instructions to:
determine an optimal point to be a best point found thus far, and
utilize the determined optimal point to perform the fine search.

17. The device of claim 15, wherein the data communication link is a serial data communication link.

18. The device of claim 15, wherein the processor is configured to execute instructions to determine the optimal signal quality based on at least one of: a threshold level and a mathematical calculation.

19. The device of claim 15, further comprising an equalizer,
wherein the equalization coefficients are determined through one of: the equalizer and the processor in conjunction with the equalizer.

20. The device of claim 15, wherein the processor is further configured to utilize another prediction of the optimal points in conjunction with the iterative scanning to further refine the optimal points.
